(19) United States
(12) Patent Application Publication
(10) Pub. No.: US 2004/0232632 A1
(43) Pub. Date: Nov. 25, 2004

(54) System and method for dynamically controlling the stability of an articulated vehicle

(76) Inventors: Michael S. Beck, Colleyville, TX (US); Kevin L. Conrad, Mansfield, TX (US)

Correspondence Address: Daren C. Davis, Williams, Morgan & Amerson, P.C., Suite 1100, 10333 Richmond, Houston, TX, 77042, US

(21) Appl. No.: 10/784,341

(22) Filed: Feb. 23, 2004

Related U.S. Application Data
(60) Provisional application No. 60/449,271, filed on Feb. 21, 2003.

(51) Int. Cl. B60G 17/01

(52) U.S. Cl. 280/5.5; 701/37

(57) ABSTRACT

A method of controlling stability of a vehicle having an articulated suspension includes determining at least one dynamic property of the vehicle and manipulating the articulated suspension based on the at least one dynamic property to affect the stability of the vehicle. A method of controlling stability of a vehicle having an articulated suspension includes determining a damping scenario and adjusting damping levels of a plurality of active dampers of the articulated suspension. A method of controlling stability of a vehicle having an articulated suspension includes determining a load on each of a plurality of wheel assemblies of the articulated suspension and manipulating at least one component of the vehicle to affect at least one of a center of gravity of the vehicle and the vehicle's stability limits.

The earlier effective filing date is claimed of co-pending U.S. Provisional Application Ser. No. 60/449,271, entitled “Unmanned Ground Vehicle,” filed Feb. 21, 2003, in the name of Michael S. Beck, et al. (Docket No. 2063.005190/VS-00607), for all common subject matter. Further, the earlier effective filing date is claimed of co-pending U.S. application Ser. No. 10/639,278, entitled “Vehicle Having an Articulated Suspension and Method of Using Same”, filed Aug. 12, 2003, in the name of Michael S. Beck et al. (Docket No. 2063.004600/VS-00582), for all common subject matter.

### BACKGROUND OF THE INVENTION

1. Field of the Invention

This invention relates to a system and method for controlling the stability of a vehicle and, in particular, to a system and method for controlling the stability of an articulated vehicle.

2. Description of the Related Art

Controlling motion in basic objects is quite simple. However, as objects become more and more complex, so do the systems and methods to control their motion. For each additional component, additional relationships are created, thus making the systems and methods to control their motion more and more complex. With changes in the relative motion of the components come changes in the aggregate location of the center of gravity (“CG”) and, in some cases the stability limits of the object. One definition of the term “stability” is the property of a body that causes it, when disturbed from a condition of equilibrium or steady motion, to develop forces or moments that restore the original condition of equilibrium. Based on this definition, the stability limits of an object may be characterized as the limits of motion that, when exceeded, will develop forces or moments to cause the body to continue to move away from its equilibrium position.

Aside from manipulating on-board payloads, the ability to control the CG position and/or the stability limits of traditional ground vehicles (both manned and unmanned) is limited. The majority of the mass of such vehicles is typically attributed to their chassis, i.e., the vehicle's sprung mass (inside the suspension) is very large relative to its unsprung mass (outside the suspension). Stability limits are static in conventional vehicles but may change in articulated vehicles due to changes in a vehicles footprint. Conventional vehicles simply lack enough unsprung mass or controlled range of motion of offboard components (e.g., suspension components) to appreciably change the CG and/or stability limits of the vehicle. While conventional control systems exist that address stability, these systems typically are limited to monitoring the vehicle's CG relative to its stability limits and either initiating warning devices or countersteering in the event stability limits are near breaching. Thus, controlling the motion of a conventional vehicle is traditionally focused on controlling the motion of the chassis, as the dynamic effects of the other components attached thereto are negligible.

Controlling the motion and attitude of more complex vehicles, such as articulated, ground vehicles, cannot generally be simplified in the same ways as these conventional ground vehicles. For example, some components of the vehicle (e.g., wheels and wheel drives) may not be mounted to the chassis. Further, a significant portion of the vehicle's mass may be found in components other than the chassis, and the non-chassis mass may contribute significantly to the vehicle's overall dynamic response. For instance, the wheels and wheel drives may be mounted to suspension arms that articulate with respect to the chassis.

Conventional controllers and control methodologies generally employ fixed parameter, linear controller structures for controlling complex non-linear systems. These controllers and methodologies typically focus on the statically determinate case of the system being controlled, failing to address the overall dynamic properties of the system. Such controllers and methodologies are, therefore, not well suited for controlling articulated vehicles.

The present invention is directed to overcoming, or at least reducing, the effects of one or more of the problems set forth above.

### SUMMARY OF THE INVENTION

In one aspect of the present invention, a method of controlling stability of a vehicle having an articulated suspension is provided. The method includes determining at least one dynamic property of the vehicle and manipulating the articulated suspension based on the at least one dynamic property to affect the stability of the vehicle.

In another aspect of the present invention, a method of controlling stability of a vehicle having an articulated suspension is provided. The method includes determining a damping scenario and adjusting damping levels of a plurality of active dampers of the articulated suspension.

In yet another aspect of the present invention, a method of controlling stability of a vehicle having an articulated suspension is provided. The method includes determining a load on each of a plurality of wheel assemblies of the articulated suspension and manipulating at least one component of the vehicle to affect at least one of a center of gravity of the vehicle and the vehicle's stability limits.

In another aspect of the present invention, a system for controlling stability of a vehicle having an articulated suspension is provided. The system includes a plurality of sensors for sensing a state of the vehicle and a controller coupled with the plurality of sensors and adapted to articulate at least one component of the vehicle to affect at least one of the vehicle's center of gravity and the vehicle's stability limits.

In yet another aspect of the present invention, a vehicle is provided. The vehicle includes a chassis and at least one component articulable with respect to the chassis. The vehicle further comprises a plurality of sensors for sensing a state of the vehicle and a controller coupled with the plurality of sensors and adapted to articulate the at least one articulable component to affect at least one of the vehicle's center of gravity and the vehicle's stability limits.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIGS. 1A-1C are stylized, side elevational, end elevational, and top plan views, respectively, of an illustrative embodiment of a vehicle according to the present invention;

FIGS. 2A-2B are partial cross-sectional and exploded views, respectively, of an illustrative embodiment of a shoulder joint of the vehicle of FIGS. 1A-1C;

FIGS. 3A-3C are pictorial views of an illustrative embodiment of a locking mechanism for the shoulder joint of FIGS. 2A-2B;

FIG. 4 is a pictorial view of an illustrative embodiment of the vehicle of FIGS. 1A-1C;

FIGS. 5A-5B are pictorial and cross-sectional views, respectively, of an illustrative embodiment of an active damper for use with the shoulder joint of FIGS. 2A-2B;

FIG. 5C is an enlarged, cross-sectional view of a portion of the damper of FIG. 5B;

FIGS. 6A-6B are pictorial and exploded pictorial views, respectively, of an illustrative embodiment of a wheel assembly of the vehicle of FIGS. 1A-1C and FIG. 4;

FIG. 7A is a cross-sectional view of an illustrative embodiment of a hub drive of the wheel assembly of FIGS. 6A-6B in park mode;

FIG. 7B is an enlarged view of a portion of the hub drive of FIG. 7A;

FIGS. 8-10 are cross-sectional views of the hub drive of FIG. 7A in high speed, neutral, and low speed modes, respectively;

FIG. 11 is a flow chart of a first illustrative embodiment of a method of controlling stability of an articulated vehicle;

FIG. 12 is a flow chart of a second illustrative embodiment of a method of controlling stability of an articulated vehicle;

FIG. 13 is a stylized block diagram of an illustrative embodiment of a predictive control model according to the present invention;

FIG. 14 is a stylized block diagram of an illustrative embodiment of a system for controlling an attitude of an articulated vehicle according to the present invention;

FIGS. 15A-15B are stylized views of a vehicle according to the present invention including a linearly articulable suspension;

FIG. 16 is a stylized view of an articulated vehicle according to the present invention including a turret; and

FIG. 17 is a stylized view of an articulated vehicle according to the present invention including a mast.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present invention pertains to dynamically controlling the stability of a ground vehicle, and, more particularly, to dynamically controlling the CG and/or the stability limits of a ground vehicle to affect its stability. For example, according to the present invention, the stability of the vehicle may be controlled by dynamically manipulating articulated components of the vehicle and/or the attitude of the vehicle's chassis to alter the CG of the vehicle and/or the stability limits of the vehicle. As it relates to the present invention, the term “attitude” means the position of the ground vehicle in three-dimensional space, determined by the relationship between its axes and a reference datum. This methodology may be advantageously used, for example:

to increase stability and limit roll, pitch and yaw characteristics; or

to decrease stability to increase responsiveness on the three axes or to overcome inertia and induce rotational or linear motion of the aggregate body.

The embodiments illustrated herein correspond to unmanned, ground, combat vehicles, but the invention is not so limited. Indeed, some aspects of the invention are not limited even to unmanned ground vehicles, but may be applied to any ground vehicle. The design of a particular embodiment of an unmanned, ground vehicle will first be discussed, followed by a discussion of a attitude control methodology and a system for controlling the attitude of the vehicle, each according to the present invention.

### I. DESIGN OF THE VEHICLE

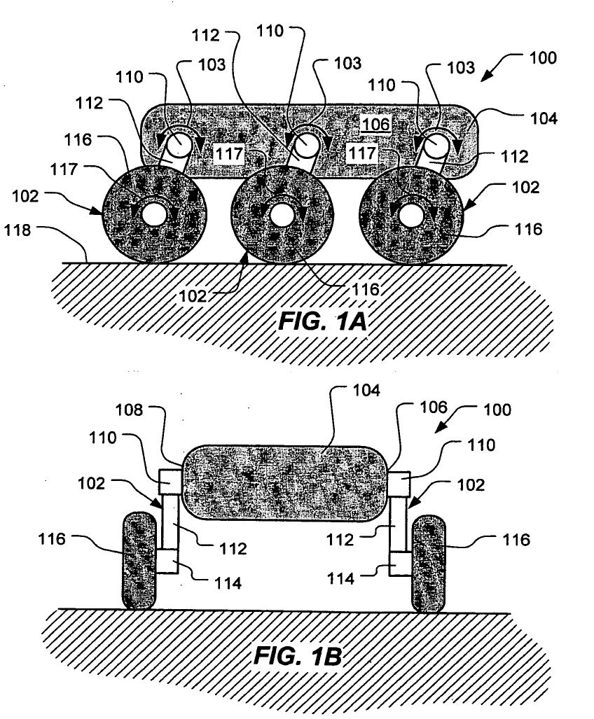

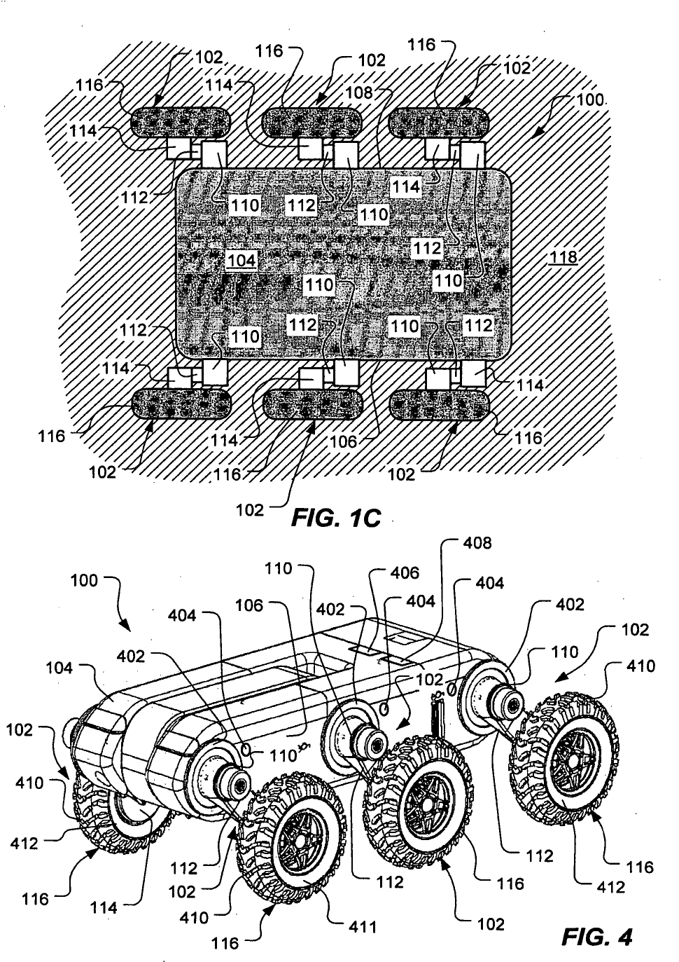

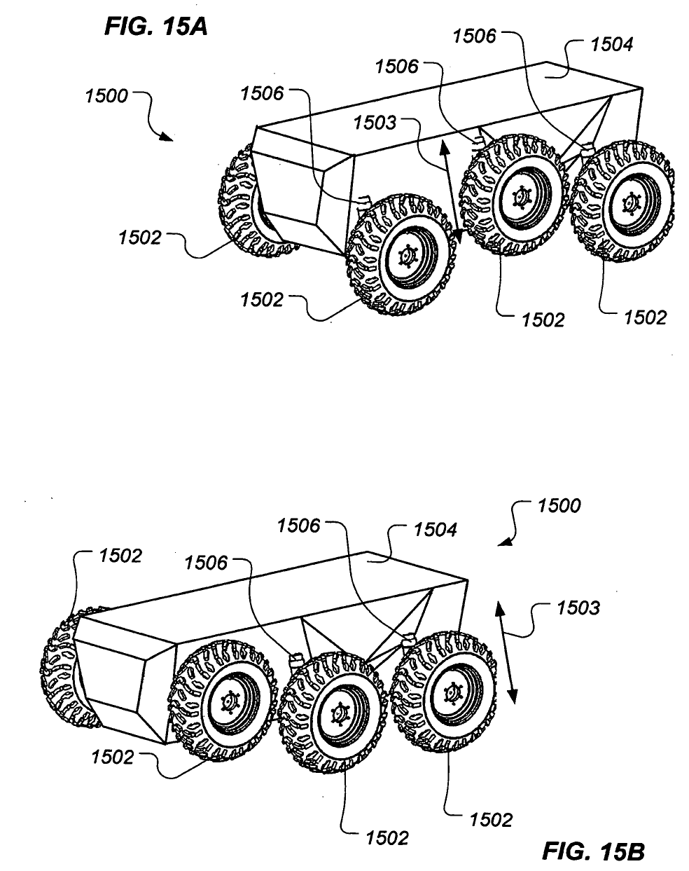

FIG. 1A-FIG. 1C are a side elevational view, an end elevational view, and a top plan view, respectively, of an illustrative embodiment of the vehicle 100 according to the present invention. The vehicle 100 comprises a plurality of wheel assemblies 102 articulated with a chassis 104. In the illustrated embodiment, each of the plurality of wheel assemblies 102 is rotationally articulated with the chassis 104, as indicated by arrows 103. Other articulations, however, are possible, such as linear articulations. For instance, FIG. 15A-FIG. 15B depict one particular embodiment of an articulated vehicle 1500 comprising a plurality of wheel assemblies 1502 (only four shown) that are each independently, linearly articulated (as indicated by arrow 1503) with respect to a chassis 1504 by an actuator 1506 (only three shown in FIG. 15A, only two shown in FIG. 15B). FIGS. 15A-15B illustrate only two of a multitude of articulated poses that the vehicle 1500 may take on. While the discussion below particularly relates to the vehicle 100, which employs rotational articulation, the present invention is not so limited. Rather, the scope of the present invention relates to a vehicle utilizing any type of articulation, as the embodiments of FIGS. 1A-1C and FIG. 15 are merely two of many types of articulated vehicles encompassed by the present invention.

In the embodiment illustrated in FIGS. 1A-1C, the wheel assemblies 102, when attached to the chassis 104, implement an articulated suspension system for the vehicle 100. Thus, by way of example and illustration, the articulated suspension system is but one articulable means for rolling the chassis 104 along a path in accordance with the present invention.

Each of the wheel assemblies 102 comprises a link structure or suspension arm, 112, a wheel 116 articulable with respect to the link structure 112, and a hub drive 114 for rotating the wheel 116. The vehicle 100, as illustrated in FIG. 1A-FIG. 1C, includes six wheel assemblies 102. The present invention, however, is not limited to a vehicle (e.g., the vehicle 100) having six wheel assemblies 102. Rather, the scope of the present invention encompasses such a vehicle having any chosen number of wheel assemblies 102, for example, four wheel assemblies 102 or eight wheel assemblies 102.

The vehicle 100, for example, may comprise the same number of wheel assemblies 102 articulated with a first side 106 and articulated with a second side 108 of the chassis 104, as shown in FIG. 1A-FIG. 1C. However, the vehicle 100 may alternatively include a different number of wheel assemblies 102 articulated with the first side 106 than are articulated with the second side 108. Thus, for example, the scope of the present invention encompasses a vehicle (e.g., the vehicle 100) having three wheel assemblies 102 articulated with the first side 106 and four wheel assemblies 102 articulated with the second side 108.

Generally, a vehicle 100, such as the one shown in FIG. 1A-FIG. 1C, comprises:

the chassis 104;

a plurality of suspension arms 112;

a shoulder joint for articulating each of the suspension arms 112 with the chassis 104;

an active damper (e.g., a magnetorheological (“MR”) rotary damper) connecting each of the suspension arms 112 to the chassis 104;

a drive train for propelling the vehicle 100; and

a power system for powering the drive train, control system, and other elements of the vehicle 100.

Each of these components will now be discussed in turn.

### A. The Chassis

The chassis 104 is illustrated in FIG. 1A-FIG. 1C (and others) in a stylized fashion and, thus, corresponds to any chosen type of chassis 104 for the vehicle 100. For example, the chassis 104 may have a configuration capable of carrying cargo or personnel, capable of deploying armaments, adapted for reconnaissance tasks, or capable of assisting dismounted personnel to traverse an obstacle to their progress. Important design considerations include: structural strength; stiffness; survivability; weight; stiffness-to-weight ratio; damage tolerance; repairability; corrosion resistance; modularity; and optimized component packaging and integration.

### B. The Suspension Arms

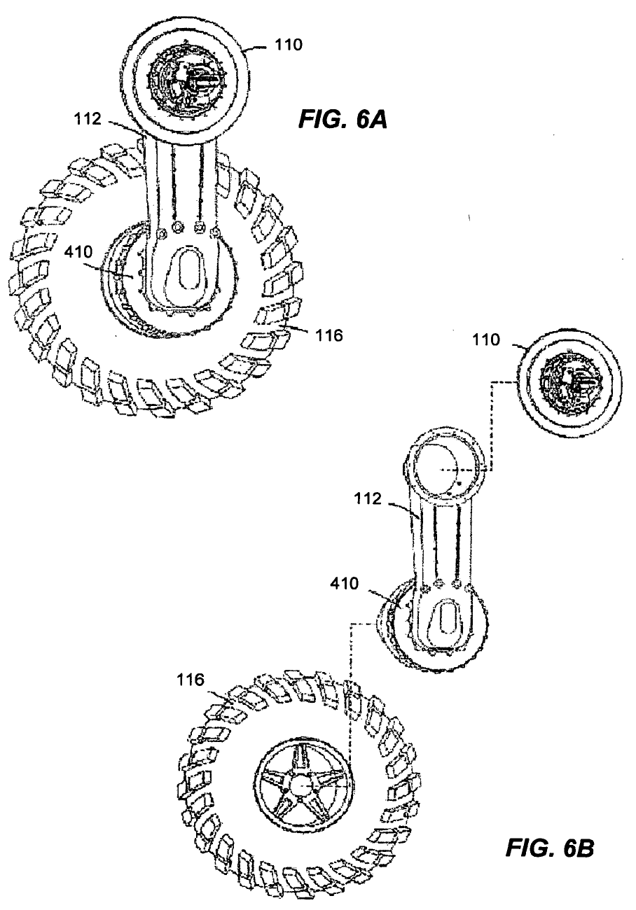

As is best shown in FIG. 6A-FIG. 6B, one embodiment of the suspension arm 112 has a hollow construction that is structurally efficient and provides for mounting of motors, controller, wiring, etc., within the suspension arm 112. The suspension arm 112 is subject to multidirectional bending, shocks and debris impact/wear. The suspension arm 112 is, in the illustrated embodiment, made of ceramic (alumina) fiber reinforced aluminum alloy, i.e., the suspension arm 112 comprises a “metal matrix composite” material. This material provides for high thermal conductivity, high specific stiffness, high specific strength, good abrasion resistance and long fatigue life.

Some embodiments may include ceramic particulate reinforcement in at least selected portions. Alternatively, the suspension arms 112 may comprise aluminum with a carbon fiber laminated overwrap. The suspension arm 112 therefore also provides mechanical protection and heat sinking for various components that may be mounted on or in the suspension arm 112. Note that the length of the suspension arm 112 may be varied depending on the implementation. In alternative embodiments, a double “A-arm” wishbone suspension (not shown) may be used instead of the articulated, trailing suspension arm design of the illustrated embodiment.

### C. The Shoulder Joints

Still referring to FIG. 1A-FIG. 1C, each of the wheel assemblies 102 is independently articulated with the chassis 104 by one of a plurality of driven shoulder joints 110. When a particular shoulder joint 110 is articulated, the wheel assembly 102 coupled therewith is articulated with respect to the chassis 104. In this particular embodiment, the articulation of each shoulder joint comprises in-plane rotation. As discussed above, however, other articulations are possible and are within the scope of the present invention. Each of the shoulder joints 110 may be driven by independent drives (i.e., not mechanically linked to each other) or two or more of the shoulder joints 110 may be driven by components of a power transmission system (e.g., a geartrain with clutched power take-offs) capable of operating each of the shoulder joints 110 independently. Each of the shoulder joints 110 may be driven by the same type of drive or they may be driven by different types of drives.

Each of the wheel assemblies 102 may be independently articulated, via its shoulder joint 110, to any desired rotational position with respect to the chassis 104 at a chosen speed. For example, in the illustrated embodiment, each of the wheel assemblies 102 may be moved from a starting rotational position (e.g., a “zero” or “home” rotational position) to a rotational position of 45 degrees clockwise, to a rotational position of 350 degrees counterclockwise, or to any other desired rotational position. Each of the wheel assemblies 102 of the illustrated embodiment may be rotated via its shoulder joint 110 more than a full revolution (i.e., more than 360 degrees).

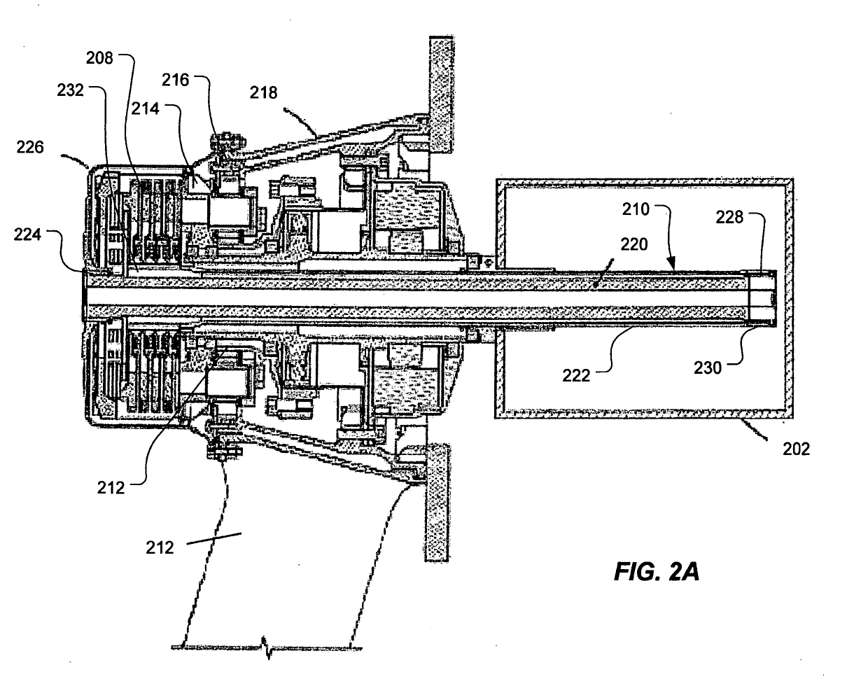

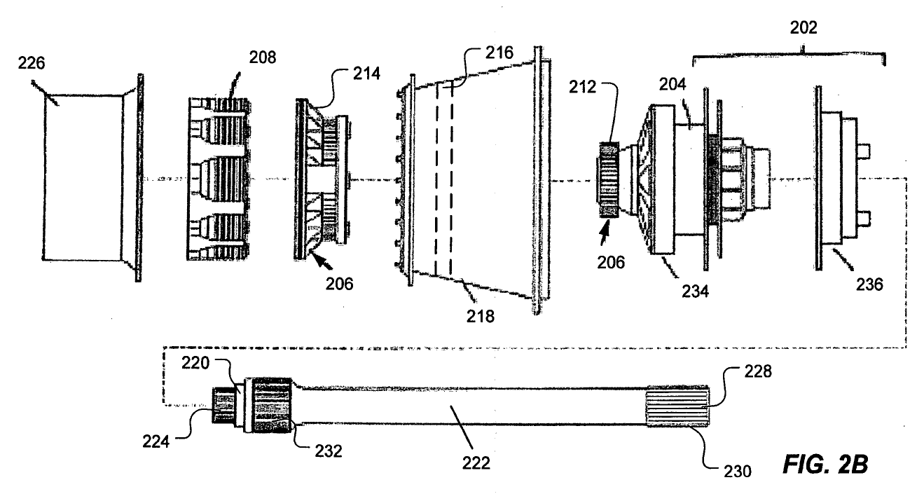

FIG. 2A-FIG. 2C depict one particular illustrative embodiment of the shoulder joint 110. The shoulder joint 110 comprises, in the embodiment illustrated in FIG. 2A-FIG. 2C, a drive 202, a harmonic drive 204, a planetary gear set 206, a slip clutch 208, and a torsion bar assembly 210 connected in series between the chassis 104 and a link structure 112 (each shown in FIG. 1A-FIG. 1C). The planetary gear set 206 includes a sun gear 212 that engages a planetary gear 214 that, in turn, engages a ring gear 216 on the interior of a housing 218. The torsion bar assembly 210 includes an inner torsion bar 220 and an outer torsion bar 222. The inner torsion bar 220 includes, on one end thereof, a plurality of splines 224 that engage an end bell 226. The inner torsion bar 220 is nested within the outer torsion bar 222 and includes, on the other end, a plurality of splines 228 that engage an interior of a cup 230 of the outer torsion bar 222. The outer torsion bar 222 also includes a plurality of splines 232 that engages the slip clutch 208.

The shoulder joint 110 also includes a housing 218 to which the suspension arm 112 is attached. Note that, in the illustrated embodiment, the suspension arm 112 is fabricated integral to the housing 218, i.e., the housing 218 and the suspension arm 112 structurally form a single part. A plurality of bearings (not shown) is disposed within the housing 218. The bearings interact with the planetary gear set 206 to rotate the housing 218 and, hence, the suspension arm 112. The shoulder joint 110 is capped in the illustrated embodiment by the end bell 226 to transmit torque between the torsion bar assembly 210 and the suspension arm 112, as well as to help protect the shoulder joint 110 from damage and debris.

The drive 202 is, in the illustrated embodiment, an electric motor including a rotor 234 and a stator 236. The drive 202 can be co-aligned along the same axis of the shoulder joint 110, as depicted in the illustrated embodiment. Alternatively, the drive 202 can be offset (not shown) and connected to the axis of actuation through a transmission, e.g., a chain-driven transmission. The drive 202 does not have to be electric, and can be a hydraulic, pneumatic, or a hybrid motor system. The drive 202 may comprise any type of drive known to the art, for example, a direct drive motor, a servo motor, a motor-driven gear set, an engine-driven gear set, a rotary actuator, or the like. The drives 202 may be mechanically independent drives (i.e., not mechanically linked to each other) or may be components of a power transmission system (e.g., a gear train with clutched power take-offs) capable of operating each of the drives 202 independently.

The harmonic drive 204 and the planetary gear set 206 implement a mechanical transmission. Some embodiments may include alternative mechanical transmissions and may also include a spur gear train, a traction drive, etc., in implementing a mechanical transmission. Mechanical transmissions have three primary applications in machine design: speed reduction, transferring power from one location to another, and converting motion from prismatic to rotary or vice versa. The shoulder joint 110 employs the mechanical transmission for speed reduction, which proportionally increases torque to rotate the wheel assembly 102. For most moving parts, bearings are used to reduce friction and typically are designed in pairs to protect against both radial and thrust loading on the actuator. Since the bearings transfer loads, the structure or housing of the shoulder actuator should be designed adequately to preclude structural failures and deflections. The harmonic drive 204 provides a first speed reduction and the planetary gear set 206 provides a second speed reduction.

The drive 202 and the transmission (i.e., the harmonic drive 204 and planetary gear set 206) may be considered the heart of the actuator for the shoulder joint 110. The remaining components facilitate the operation of the drive 202 and the transmission and may be omitted in various alternative embodiments (not shown). A clutch assembly (i.e., the slip clutch 208) may be integrated such that the linked wheel assembly 102 may be disengaged (not powered or controlled) where positioning is passive based only on gravity effects. The slip clutch 208 also limits the torque through the drive system and is capable of dissipating energy to prevent damage. Similarly, a torsion assembly (i.e., the torsion bar assembly 210) may be used to control the twist properties of the shoulder joint 110 by actively engaging different effective torsion bar lengths. Thus, some embodiments may include the slip clutch 208 and/or the torsion bar assembly 210, whereas others may omit them.

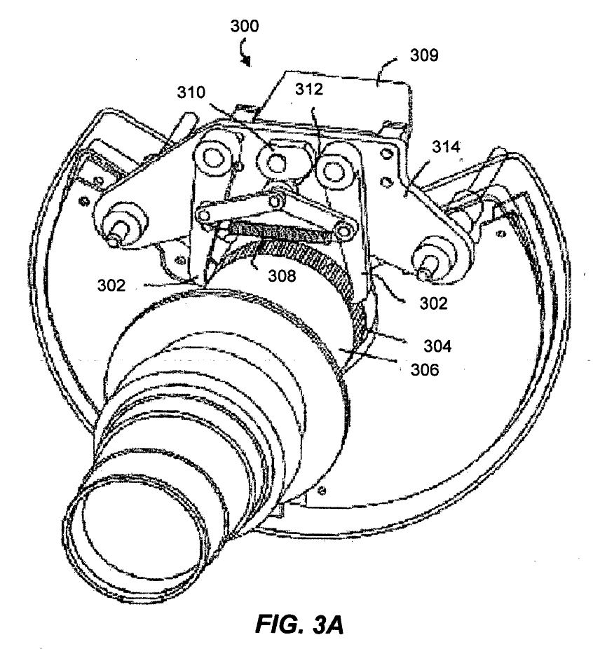

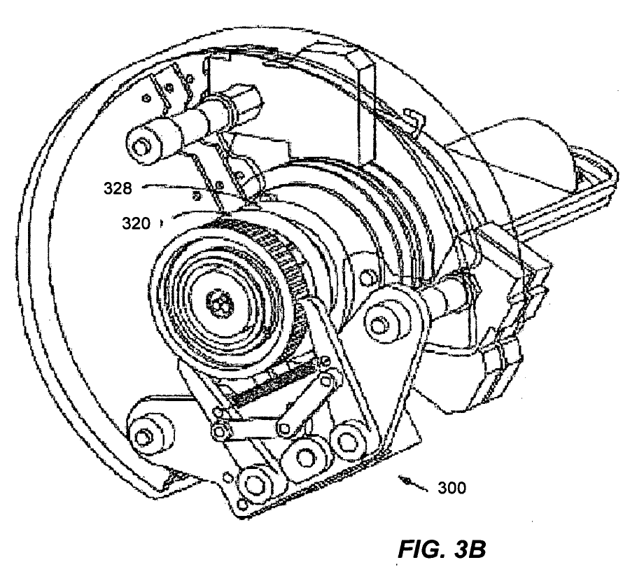

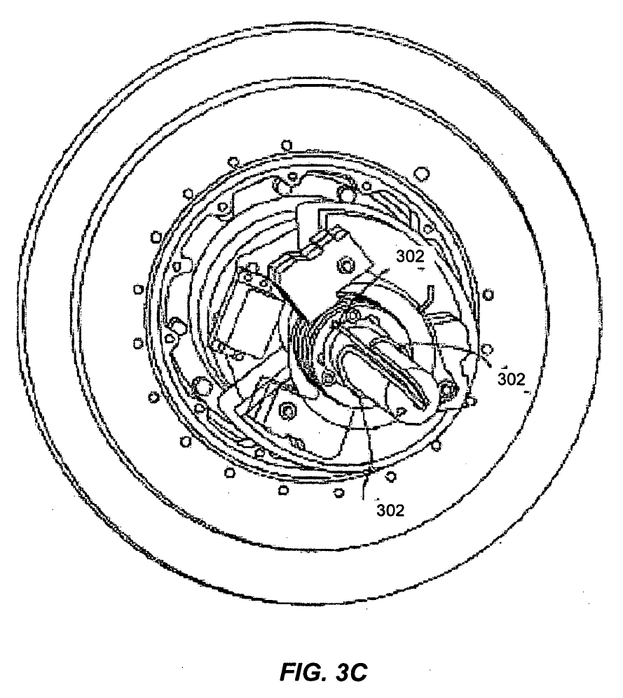

As is shown in FIG. 3A-FIG. 3B, in one embodiment, a small spring-applied, electrically released locking mechanism 300 prevents rotation of the drive 202 so that power is not required when the vehicle 100 is static. The locking mechanism 300 is a fail-safe/power-off device, which is spring actuated or actuated by using another motor to incrementally increase the friction between two surfaces based on pressure (i.e., a clamping effect). Thus, the locking mechanism 300 is able to lock the joint at a prescribed position.

More particularly, the locking mechanism 300 of the illustrated embodiment includes a pair of pawls 302 that interact with a toothed lock ring 304 on the motor shaft 306 of the drive 202. A spring 308, or some other biasing means, biases the pawls 302 to close on the lock ring 304 when the cam 310 is positioned by the servo-motor 309 to allow for movement of the driver 312 and linkage. To unlock the locking mechanism 300, the servo-motor 309 actuates the cam 310 to operate against the driver 312 and open the pawls 302 away from the lock ring 304. Note that the pawls 302, the servo-motor 309, cam 310, and driver 312 are all mounted to a mounting plate 314 that is affixed to the chassis 104 (shown in FIG. 1). When the locking mechanism 300 is engaged, no power is required. However, in some alternative embodiments, a spring-applied brake may be used to facilitate locking the actuator shaft 306. In these embodiments, the locking mechanism 300 will still lock the shoulder joint 110 on power failure, but will consume power when unlocked, as long as power is available.

Returning to FIG. 2A-FIG. 2C, the drive 202, sensors (discussed below), control system (discussed below), slip clutch 208, and locking mechanism 300 (shown in FIG. 3A-FIG. 3C) all require power. Power is provided by the vehicle 100 (shown in FIG. 1) to each shoulder joint 110 and moreover, some power is passed through from the vehicle chassis 104 through the shoulder joint 110 and to the hub drive 114 to drive the wheel 116. In addition to power, data signals follow the same path. To pass power and data signals over the rotary shoulder joints 110, a plurality of slip rings 332, shown in FIG. 3C, are used. The supply of power should be isolated from data due to noise issues, and the illustrated embodiment employs separate slip rings to-transmit power and data. Note that conductors (not shown) are attached to each side of the slip rings 332, with each side rotatably in contact with each other to maintain continuity.

### D. The Active Dampers

Vibrations or other undesirable motions induced into the vehicle 100 by rough terrain over which the vehicle 100 travels may be dampened by the mechanical compliance of the wheels 116. In other words, the wheels 116 deform to absorb the shock forces resulting from traveling over rough terrain. Such shock forces may be absorbed by optional shock absorbers, spring elements, and/or dampers, such as those known to the art.

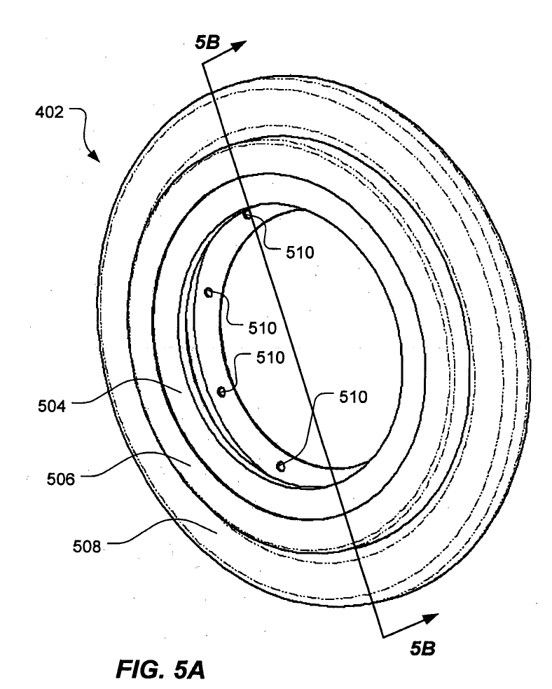

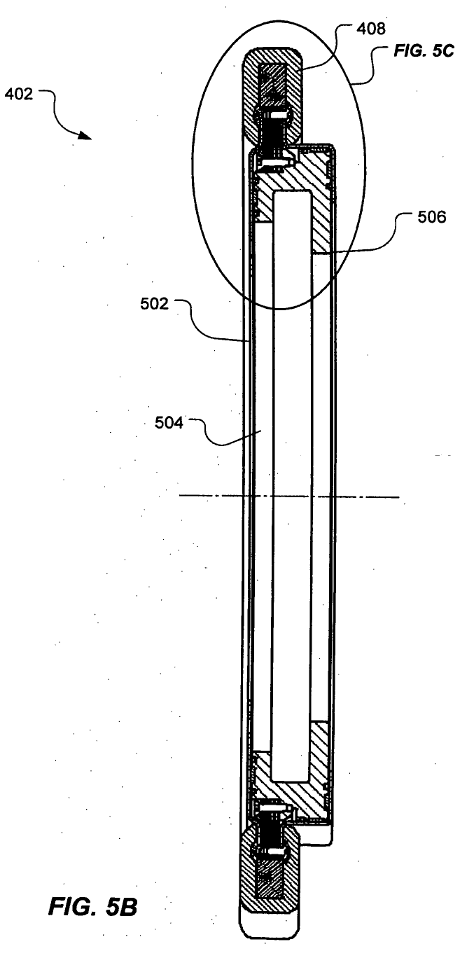

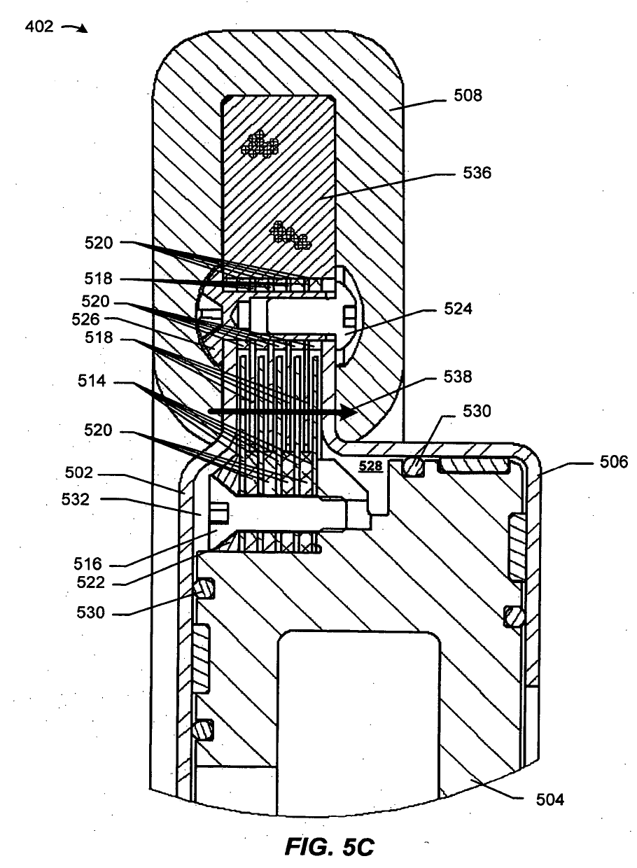

Other options include the integration of an active damper to add additional dampening suspension characteristics. In the embodiment illustrated in FIG. 4, the vehicle 100 comprises a controllable, magnetorheological (MR) fluid based, rotary damper 402, which is merely one type of active damper, connecting the suspension arm 112 to the chassis 104, mounted in parallel with the shoulder joint 110. The rotary MR damper 402, first shown in FIG. 4 but best shown in FIG. 5A-FIG. 5C, at each suspension arm 112 provides actively variable damping torque controlled by a central computer (discussed below). The rotary MR damper 402 acts as a Coulomb damper, rather than a dashpot. This control allows for optimized vehicle dynamics, improved traction, articulation, impact absorption and sensor stabilization. The system improves obstacle negotiation by enabling the shoulder joints 110 to be selectively locked, improving suspension arm 112 position control. Damping is controllable via a magnetically sensitive fluid. The fluid shear stress is a function of the magnetic flux density. The flux is generated by an integrated electromagnet that is capable of varying the resultant damping torque in real time.

The MR rotary damper 402 controls the applied torque on the shoulder joint 110 during all of the vehicle operational modes. It provides the muscle to the vehicle 100 for absorbing impacts, damping the suspension and accurately controlling the position of the joint. The MR rotary damper 402 increases traction and decreases the transmission of vertical accelerations into the chassis 104. The MR damper 402's ability to change damping force in real-time via software control maintains suspension performance over all operating conditions, such as changing wheel loads, varying wheel positions, and varying the vehicle 100 center of gravity.

Still referring to FIG. 5A-FIG. 5C, the rotary damper 402 includes an inner housing 502, a rotor 504, an outer housing 506, and a segmented flux housing 508. The inner housing 502, outer housing 506, and segmented flux housing 508 are fabricated from a “soft magnetic” material (i.e., a material with magnetic permeability much larger than that of free space), e.g., mild steel. The rotor 504 is made from a “nonmagnetic” material (i.e., a material with magnetic permeability close to that of free space), e.g., aluminum. In one embodiment, the segmented flux housing 508 is fabricated from a high performance magnetic core laminating material commercially available under the trademark HIPERCO 50® from:

Carpenter Technology Corporation
P.O. Box 14662
Reading, PA 19612-4662
U.S.A.

However, other suitable, commercially available soft magnetic materials, such as mild steel, may be used.

The rotary damper 402 is affixed to, in this particular embodiment, a chassis 104 by fasteners (not shown) through a plurality of mounting holes 510 of the inner housing 502. The rotor 504 is made to rotate with the pivoting element (not shown)with the use of splines or drive dogs (also not shown). Note that the rotary damper 402 may be affixed to the suspension arm 112 and the chassis 104 in any suitable manner known to the art. The rotary damper 402 damps the rotary movement of the arm pivot relative to the chassis 104 in a manner more fully explained below.

Referring to FIG. 5C, pluralities of rotor plates 514, separated by magnetic insulators 520, are affixed to the rotor 504 by, in this particular embodiment, a fastener 516 screwed into the rotor plate support 522 of the rotor 504. A plurality of housing plates 518, also separated by magnetic insulators 520, are affixed to an assembly of the inner housing 502 and outer housing 506, in this embodiment, by a fastener 524 in a barrel nut 526. Note that the assembled rotor plates 514 and the assembled housing plates 518 are interleaved with each other. The number of rotor plates 514 and housing plates 518 is not material to the practice of the invention.

The rotor plates 514 and the housing plates 518 are fabricated from a soft magnetic material having a high magnetic permeability, e.g., mild steel. The magnetic insulators 520, the fasteners 516, 524, and the barrel nut 526 are fabricated from nonmagnetic materials, e.g., aluminum or annealed austenitic stainless steel. The nonmagnetic fasteners can be either threaded or permanent, e.g., solid rivets. The rotor plates 514 and the housing plates 518 are, in this particular embodiment, disc-shaped. However, other geometries may be used in alternative embodiments and the invention does not require that the rotor plates 514 and the housing plates 518 have the same geometry.

Still referring to FIG. 5C, the assembled inner housing 502, rotor 504, and outer housing 506 define a chamber 528. A plurality of O-rings 530 provide a fluid seal for the chamber 528 against the rotation of the rotor 504 relative to the assembled inner housing 502 and outer housing 506. An MR fluid 532 is contained in the chamber 528 and resides in the interleave of the rotor plates 514 and the housing plates 518 previously described above. In one particular embodiment, the MR fluid 532 is MRF132AD, commercially available from:

Lord Corporation
Materials Division
406 Gregson Drive
P.O. Box 8012
Cary, NC 27512-8012
U.S.A.

However, other commercially available MR fluids may also be used.

The segmented flux housing 508 contains, in the illustrated embodiment, a coil 536, the segmented flux housing 508 and coil 536 together comprising an electromagnet. The coil 536, when powered, generates a magnetic flux in a direction transverse to the orientation of the rotor plates 514 and the housing plates 518, as represented by the arrow 538. Alternatively, a permanent magnetic 540 could be incorporated into the flux housing 508 to bias the magnetic flux 538. The coil 536 drives the magnetic flux through the MR fluid 532 and across the faces of the rotor plates 514 and the housing plates 518. The sign of the magnetic flux is not material to the practice of the invention.

The magnetic flux 538 aligns the magnetic particles (not shown) suspended in the MR fluid 532 in the direction of the magnetic flux 538. This magnetic alignment of the fluid particles increases the shear strength of the MR fluid 532, which resists motion between the rotor plates 514 and the housing plates 518. When the magnetic flux is removed, the suspended magnetic particles return to their unaligned orientation, thereby decreasing or removing the concomitant force retarding the movement of the rotor plates 514. Note that it will generally be desirable to ensure a full supply of the MR fluid 532. Some embodiments may therefore include some mechanism for accomplishing this. For instance, some embodiments may include a small fluid reservoir to hold an extra supply of the MR fluid 532 to compensate for leakage and a compressible medium for expansion of the MR fluid 532.

Returning to the illustrated embodiment, the control system commands an electrical current to be supplied to the coil 536. This electric current then creates the magnetic flux 538 and the rotary damper 402 resists relative motion between the housings 502, 506 and the rotor 504. Depending on the geometry of the rotary damper 402 and the materials of its construction, there is a relationship between the electric current, the relative angular velocity between the housings 502, 506 and the rotor 504, and the resistive torque created by the rotary damper 402. In general this resistive torque created by the rotary damper 402 increases with the relative angular motion between the housings 502, 506 and the rotor 504 and larger magnetic flux density through the fluid 532 as generated by the coil electric current.

Unfortunately, the MR rotary damper 402 tends to have a high inductance. This problem can be mitigated with the use of high control voltages which allow for high rates of change in damper current (di/dt), although this may lead to increased power demands and higher levels of inefficiency depending on the design and the software control driving the rotary damper 402. Another technique, which may improve the bandwidth and efficiency of the MR rotary damper 402, uses multiple coil windings. One such system could use two coil windings; one high inductance, slow coil with a high number of turns of small diameter wire and a second low inductance, fast coil with a low number of turns of larger diameter wire. The slow coil could be used to bias the rotary damper 402 while the fast coil could be used to control around this bias. However, the two coil windings may be highly coupled due to the mutual inductance between them in some implementations, which would be undesirable.

The MR rotary damper 402 is but one means for actively damping the articulated suspension. Other devices may be used to actively damp the articulated suspension.

### E. The Drive Train

Referring again to FIG. 1A-FIG. 1C, each of the wheels 116 is mounted to and rotates with respect to its link structure 112 via its hub drive 114, which is capable of selectively rotating the wheel 116 (as indicated by arrows 117) at a chosen speed. This configuration provides for significant amounts of unsprung mass and an associated range of motion, which can be used to the platform's advantage in manipulating CG and stability limits. Each of the drives 114 may comprise any type of drive known to the art, for example, a direct-drive motor, a servo motor, a motor-driven gear train, an engine-driven gear train, a rotary actuator, or the like. Further, each of the drives 114 may be of the same type or they may comprise different types of drives. By actuating some or all of the drives 114 at the same or different speeds, the vehicle 100 may be propelled across a surface 118 along a chosen path.

In the particular embodiment illustrated in FIG. 4, each of the wheels 116 further comprises a tire 410 mounted to a rim 412. The tire 410 may comprise any suitable tire known to the art, such as a pneumatic tire, a semi-pneumatic tire, a solid tire, or the like.

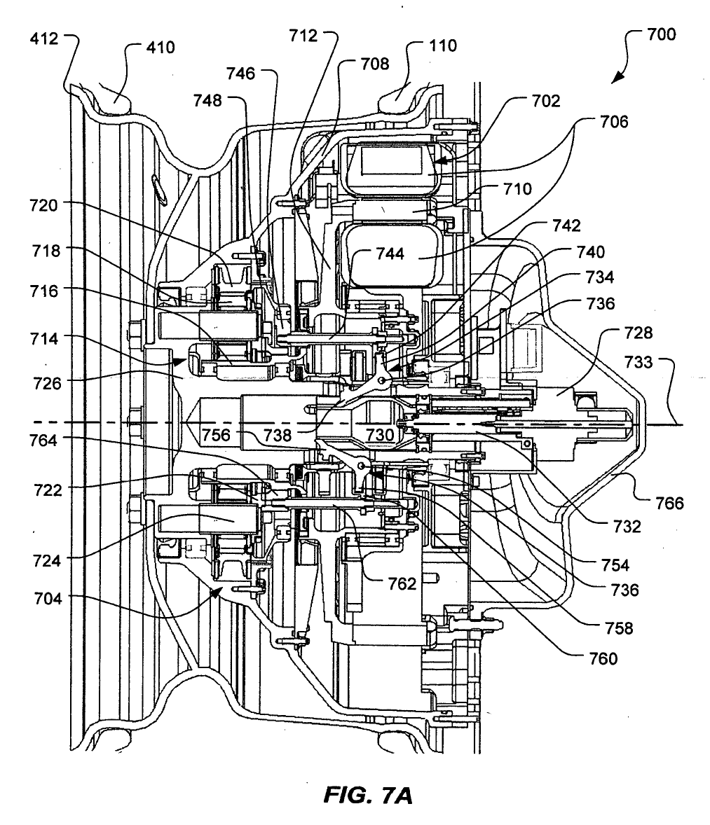

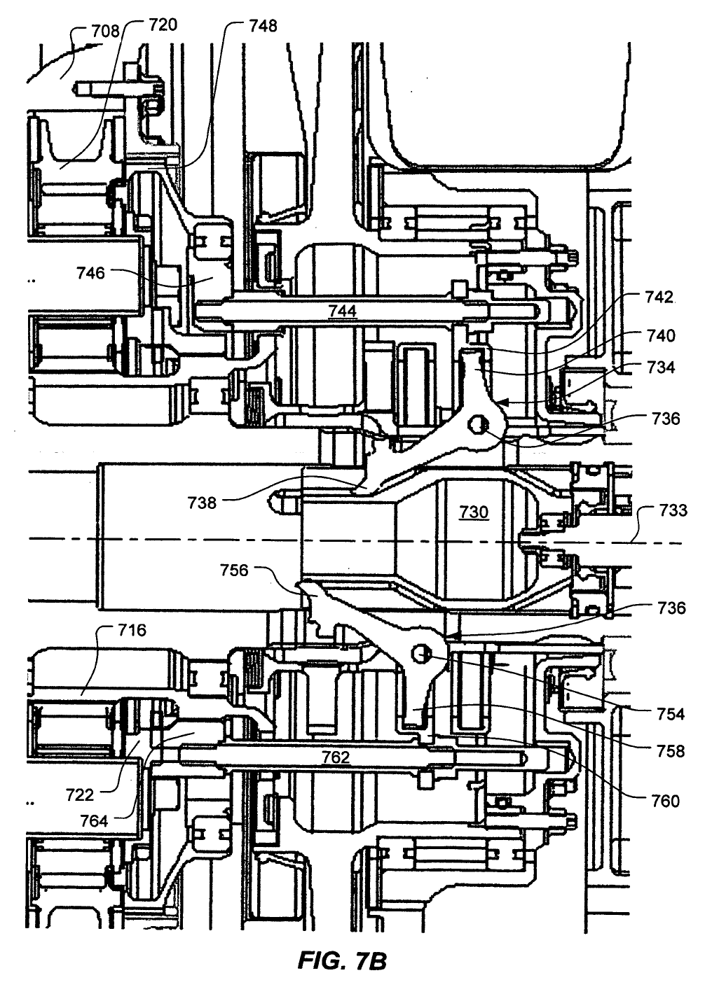

FIGS. 7A and 8-10 are cross-sectional, side views depicting the illustrated embodiment of the hub drive 114 in park mode, high speed mode, neutral mode, and low speed mode, respectively. The hub drive 114 includes a motor 702 and a transmission 704 having an input attached to the motor 702 and an output attached to the rim 412 of the wheel 108, each being disposed within the wheel 108 and, in the illustrated embodiment, being disposed within the rim 412. The motor 702 comprises a stator 706, attached to the vehicle 100 via a hub casing 708, and a rotor 710, attached to a rotor hub 712. In various embodiments, the motor 702 may comprise a variable reluctance motor, a DC brushless motor, a permanent magnet motor, or the like.

Still referring to FIGS. 7A and 8-10, the transmission 704 comprises an epicyclic gear train 714, which further includes a sun gear 716, a plurality of planetary gears 718 engaged with the sun gear 716, and a ring gear 720 engaged with the planetary gears 718. Each of the planetary gears 718 is held in position by a spindle 726 and a carrier cover plate 722 via a shaft 724. The spindle 726 and the carrier cover plate 722 implements a planetary gear carrier. The rotor hub 712, which is attached to the rotor 710 as described above, is coupled with the sun gear 716. Thus, as the motor 702 operates, the rotor 710 is caused to rotate with respect to the stator 706 and, correspondingly, rotates the sun gear 716. In the illustrated embodiment, the planetary gear carrier 722 is attached to the rim 412 by the spindle 726 and, thus, power from the motor 702 is transmitted from the motor 702, through the epicyclic gear train 714, to the rim 412.

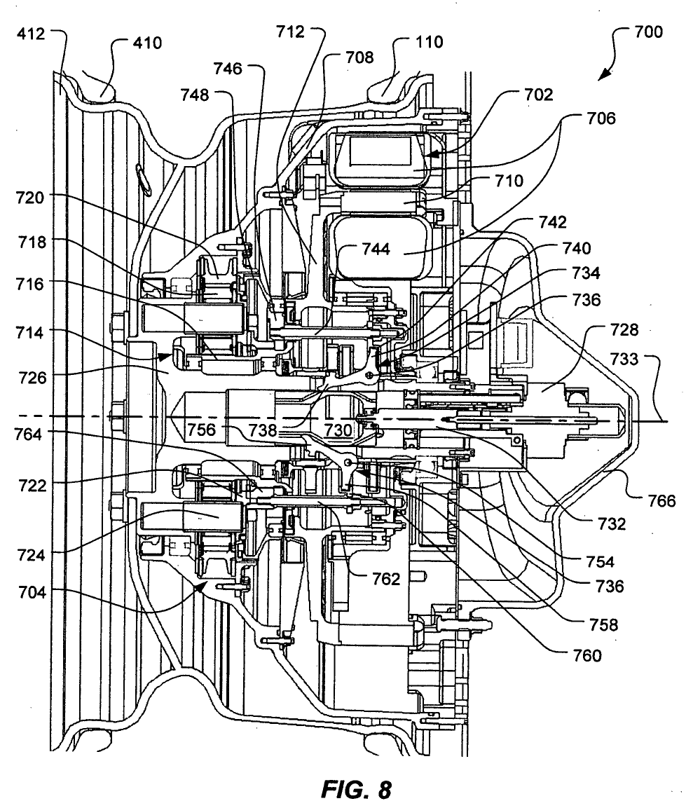

Various outputs or operating modes may be accomplished by placing the epicyclic gear train 714 in different operational configurations. For example, the hub drive 114 may be placed in park mode, shown better in FIGS. 7A-8B, by locking the planetary gear carrier 722 to the sun gear 716 and by locking the ring gear 720 to the hub casing 708, as will be discussed further below, to prevent the epicyclic gear train 714 from transmitting power therethrough. Further, the hub drive 114 may be placed in high speed mode, illustrated better in FIG. 8, by locking the planetary gear carrier 722 to the sun gear 716 and by allowing the ring gear 720 to rotate freely, causing the spindle 726 to rotate at the same speed as the rotor 710.

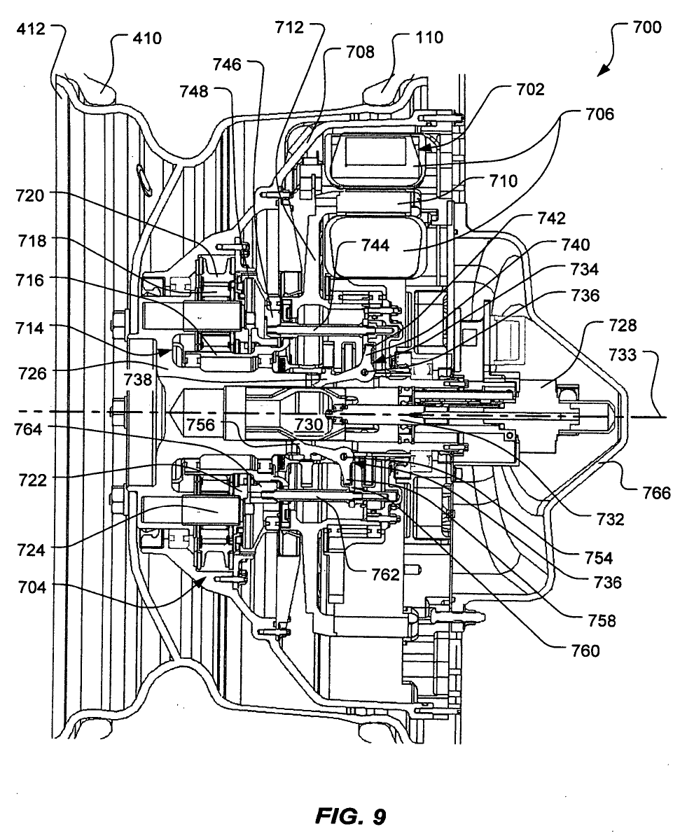

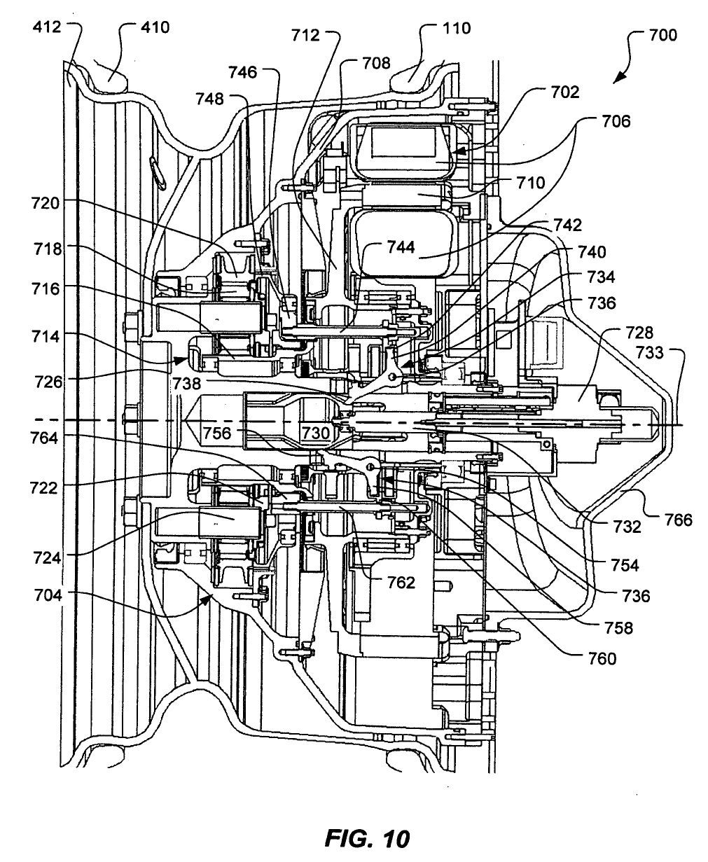

Further, to place the hub drive 114 in neutral mode, illustrated better in FIG. 9, the spindle 726 is allowed to rotate freely by causing the planetary gear carrier 722 to rotate independently of the sun gear 716 and by causing the ring gear 720 to rotate freely. The hub drive 114 may be placed in low speed mode, illustrated better in FIG. 10, by reducing the rotational speed of the spindle 726 with respect to the rotor 710. In this configuration, the planetary gear carrier 722 is allowed to rotate independently of the sun gear 716 and the ring gear 720 is locked to the hub casing 708, which causes the sun gear 716 to rotate the planetary gears 718 against the fixed ring gear 720, driving the planetary gear carrier 722 and the spindle at a lower speed than the sun gear 716.

To effect these configurations, the transmission 704 illustrated in FIGS. 7A-11 includes a shift motor 728 that linearly actuates a shift drum 730 via a shift pin 732 along an axis 733. As the shift drum 730 is moved to various positions by the shift motor 728, the epicyclic gear train 714 is shifted into the various operating modes by pivoting a first shift lever 734 and/or a second shift lever 736 via the shift drum 730. Referring now to FIG. 7B, which provides an enlarged view of a portion of the transmission 704 of FIG. 7A, the first shift lever 734 is pivotably mounted by a pin 736, such that a first leg 738 of the first shift lever 734 is biased against the shift drum 730. A second leg 740 of the first shift lever 734 extends into a first shift ring 742, which is attached to a first shift spacer 744. The first shift spacer 744 is attached to a ring gear dog hub 746, which is attached to a ring gear dog ring 748.

The ring gear dog ring 748 may be selectively contacted to the ring gear 720 to lock the ring gear 720 to the hub casing 708. For example, when the first shift lever 734 is pivoted by the shift drum 730 such that the first leg 738 thereof moves away from the axis of motion 733 of the shift drum 730, the ring gear dog ring 748 is disengaged from the ring gear 720, as shown in FIGS. 8 and 9. Conversely, when the first shift lever 734 is pivoted by the shift drum 730 such that the first leg 738 thereof moves toward the axis of motion 733 of the shift drum 730, the ring gear dog ring 748 is engaged with the ring gear 720, as depicted in FIGS. 7A, 7B, and 10.

Similarly, the transmission 704 further comprises a second shift lever 752 that is pivotably mounted by a pin 754, such that a first leg 756 of the second shift lever 752 is biased against the shift drum 730. A second leg 758 of the second shift lever 752 extends into a second shift ring 760, which is attached to a second shift spacer 762. The second shift spacer 762 is attached to a planetary carrier dog ring 764. The planetary carrier dog ring 764 may be selectively contacted to the planetary carrier 722 to lock the planetary gear carrier 722 to the sun gear 716. For example, when the second shift lever 752 is pivoted by the shift drum 730 such that the first leg 756 thereof moves away from the axis of motion 733 of the shift drum 730, the planetary carrier dog ring 764 is disengaged from the planetary gear carrier 722, as shown in FIGS. 8 and 9. Conversely, when the second shift lever 752 is pivoted by the shift drum 730 such that the first leg 756 moves toward the axis of motion 733 of the shift drum 730, the planetary carrier dog ring 764 is engaged with the planetary gear carrier 722, as shown in FIGS. 7A, 7B, and 8. A cover 766 is employed in one embodiment to protect the hub drive 714 from debris.

FIGS. 7A-7B illustrate the hub drive 114 in its park configuration. In the illustrated embodiment, the shift drum 730 is in its far outboard position. In this configuration, the first shift lever 734 is pivoted such that the planetary carrier dog ring 764 is engaged with the planetary gear carrier 732, thus locking the planetary gear carrier 732 to the sun gear 716. Further, the second shift lever 736 is pivoted such that the ring gear dog ring 748 is engaged with the ring gear 720, thus locking the ring gear 720 to the hub casing 708. As a result, the rotor 710 and the stator 706 of the motor 702 are inhibited from moving relative to each other and the spindle 726 is inhibited from rotating.

FIG. 8 depicts the hub drive 114 in its high speed configuration. In the illustrated embodiment, the shift drum 730 is positioned inboard of its park position, shown in FIG. 7A. In this configuration, the first shift lever 734 is pivoted such that the planetary carrier dog ring 764 is engaged with the planetary gear carrier 732, thus locking the planetary gear carrier 732 to the sun gear 716. Further, the second shift lever 736 is pivoted such that the ring gear dog ring 748 is disengaged from the ring gear 720, thus allowing the ring gear 720 to rotate freely. As a result, the spindle 726 is locked to the ring gear 720, creating a direct drive. In other words, the spindle 726 and the rim 412 rotates at the same speed as the motor 702.

FIG. 9 depicts the hub drive 114 in its neutral configuration. In the illustrated embodiment, the shift drum 730 is positioned inboard of its high speed position, shown in FIG. 8. In this configuration, the first shift lever 734 is pivoted such that the planetary carrier dog ring 764 is disengaged from the planetary gear carrier 732, allowing the planetary gear carrier 732 to rotate independently of the sun gear 716. Further, the second shift lever 736 is pivoted such that the ring gear dog ring 748 is disengaged from the ring gear 720, thus allowing the ring gear 720 to rotate freely. As a result, the spindle 726 may rotate independently of any rotation by the motor 702.

FIG. 10 shows the hub drive 114 in its low speed configuration. In the illustrated embodiment, the shift drum 730 is in its far inboard position. In this configuration, the first shift lever 734 is pivoted such that the planetary carrier dog ring 764 is disengaged from the planetary gear carrier 732, thus allowing the planetary gear carrier 732 to rotate independently of the sun gear 716. Further, the second shift lever 736 is pivoted such that the ring gear dog ring 748 is engaged with the ring gear 720, thus locking the ring gear 720 to the hub casing 708. As a result, the sun gear 716 rotates the planetary gears 718 against the fixed ring gear 720, thus driving the planetary gear carrier 732 and the spindle 726 at a lower speed than the motor 702.

While the shift drum 730 is described above as being in a particular inboard/outboard position corresponding to a particular operational mode, the present invention is not so limited. Rather, the scope of the present invention encompasses various designs of the hub drive 114 in which the shift drum 730 is moved to positions different than those described above to achieve the various operational modes thereof. For example, one embodiment of the hub drive 114 may be configured such that the shift drum 730 operates obversely to the operation shown in FIGS. 7A-10. In such an embodiment, the shift drum 730 may be moved from a far inboard position through intermediate positions to a far outboard position to shift the hub drive 114 from the park mode, the high speed mode, the neutral mode, to the low speed mode. Thus, the particular embodiments of the hub drive 114 disclosed above may be altered or modified, and all such variations are considered within the scope of the present invention.

The hub drive 114 is capable of rotating the wheel 108 (each shown in FIG. 1) in either direction. The rotational direction of the transmission 104 may be changed by changing the rotational direction of the motor 102. The rotational direction of the motor 102 may be changed by techniques known to the art depending upon the type of motor used.

Changing the rotational direction of the motor 102 and, thus, the rotational direction of the hub drive 101, may also be used to brake the hub drive 101 by using the motor 102 as a generator to develop negative “braking” torque. For example, if the hub drive 101 is rotating in a first direction and the motor 102 is switched such that it is urged to rotate in a second direction, the motor 102 will be “backdriven” to brake the hub drive 101.

Thus, by combining the shifting capability of the transmission 704 and the capability of the motor 702 to rotate in both directions, the hub drive 114 is capable of rotating the wheel 108 in either direction and in the low speed mode (illustrated in FIG. 4) or the high speed mode (illustrated in FIG. 2). Further, the hub drive 114 is capable of braking while rotating in either direction in the low speed mode or the high speed mode. Further, by placing the hub drive 114 in the park mode, the hub drive 114 is inhibited from rotating and, thus, no additional “parking brake” is required. Yet further, by placing the hub drive 114 in the neutral mode, the wheel 108 may rotate freely, irrespective of the rotation of the motor 702.

### F. The Power System

In one embodiment, electrical power is provided to the motors 702 (and to other electrical equipment of the vehicle 100) by a series hybrid power plant comprising a commercial, off-the-shelf-based single cylinder air-cooled, direct injection diesel engine (not shown) coupled with a commercial, off-the-shelf-based generator (not shown) disposed in the chassis 104 (shown in FIG. 1). The power plant is used in conjunction with at least one string of electrical energy storage devices (not shown), such as lead-acid or lithium-ion batteries, also disposed in the chassis 104, in a series-hybrid configured power train with sufficient buffering and storage in the power and energy management systems. The present invention, however, is not limited to use with the above-described power plant. Rather, any suitable electrical power source may be used to supply power to the motors 702 and the other electrical equipment.

### II. STABILITY CONTROL METHODOLOGY

In unmanned ground vehicles (e.g., the vehicle 100 of FIGS. 1A-1C and the vehicle 1500 of FIGS. 15A-15B), as well as in other vehicles, it is often desirable to control the vehicle's stability so that a proper course may be held while traversing along a path, discrete obstacles may be overcome, and/or anomalies, such as roll-over, may be prevented. In one embodiment, the vehicle's stability may be controlled by determining at least one dynamic property of the vehicle (e.g., the inertia, acceleration, velocity, momentum, and the like) and manipulating the articulated suspension based on the at least one dynamic property to affect the stability of the vehicle.

As the vehicle 100, 1500 travels, it will likely encounter various types of terrain. If the terrain is relatively smooth and flat, little stability control may be required. If the terrain is rough and/or hilly, however, more complex control of the vehicle 100, 1500 may be required. Each of these exemplary scenarios will be discussed in turn, followed by a discussion of an illustrative predictive model for controlling stability of an articulated vehicle, such as the vehicle 100 of FIGS. 1A-1C and the vehicle 1500 of FIGS. 15A-15B. While the discussion that follows is provided in relation to the vehicle 100 of FIGS. 1A-1C, the scope of the present invention is not so limited. Rather, the scope of the present invention encompasses the application of these methodologies to control articulated vehicles in general, including the articulated vehicle 1500 of FIGS. 15A-15B.

### A. Control for Smooth Terrain

In normal driving modes over terrain that is generally smooth, it may not be desirable to actively control the articulation of the wheel assemblies 102 with respect to the chassis 104. Rather, according to the present invention, it may be desirable to allow the active dampers (e.g., the rotary MR dampers 402) to dampen the undesired vibrations, oscillations, and/or shocks induced in the vehicle 100 by the terrain over which it travels, so that the desired stability of the vehicle 100 can be maintained. In such situations, the shoulder joints 110 are held stationary and the active dampers are set to a desired damping level.

The suspension damping level may be controlled by various factors, including the terrain and/or the mission. For example, if the vehicle 100 is traveling over a paved surface (e.g., a paved road), the damping level may be reduced. Conversely, if the vehicle 100 is traveling over a gravel surface, the damping level may be increased to dampen the undesired vibrations, oscillations, and/or shocks induced in the vehicle 100 by the more uneven, gravel surface. Alternatively, the dynamic response of the active dampers may be over-damped to stabilize a payload, such as a sensor or weapon. Further, the dynamic response may be set to enhance the vehicle 100's stability at higher traveling speeds. Yet further, the dynamic response may be under-damped to conserve system energy. In other words, the natural frequency of the vehicle 100 can be controlled by adjusting the damping level of the active dampers. By adjusting the damping level of the active dampers, forces can be either filtered by the dampers or allowed to pass through the suspension to the sprung mass (i.e, the chassis 104), thus, affecting the output response.

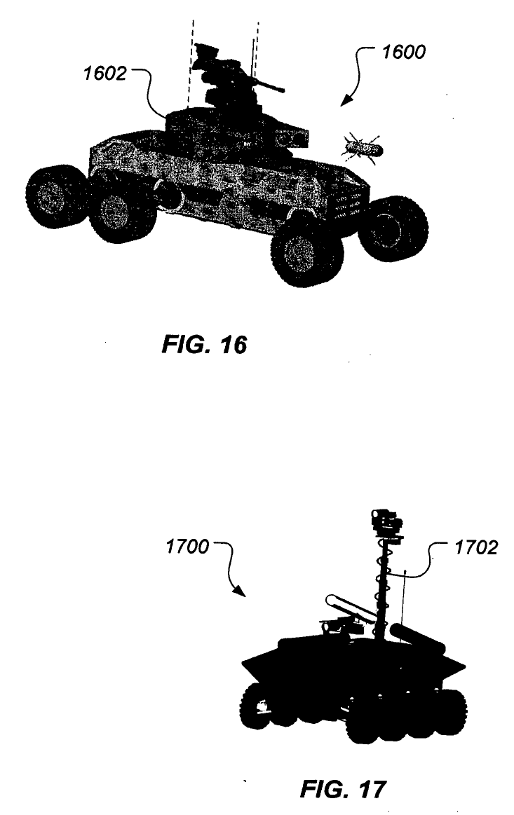

Over time as the vehicle 100 travels across the terrain, trends in dynamic response of the vehicle 100 can be analyzed to determine if the terrain has changed. For example, a trend might show that the terrain has changed from a paved surface to a gravel surface, such that a change in the damping level may be desirable. Further, for example, a trend might showthat the terrain has changed from a paved surface to rough terrain. In this case, the level of stability control may be increased, as discussed below concerning rough terrain control. The dynamic response of the vehicle 100 is also dependent upon its mass, inertia, velocity, acceleration, mission, and configuration. In addition to controlling the damping levels of the active dampers, one embodiment of the stability control method of the present invention incorporates one or more of the vehicle 100's mass, inertia, velocity, acceleration, attitude, position, and mission configuration into the methodology for controlling its stability. For example, the vehicle 100 may include one or more turrets (e.g., a turret 1602 of the vehicle 1600 of FIG. 16), masts (e.g., a mast 1702 of the vehicle 1700 of FIG. 17) for mast-mounted sensors and/or weapons (not shown), or the like, depending upon the mission configuration, that affect the dynamic response of the vehicle 100 based upon their positions with respect to the chassis 104, 1504. Further the attitude of the vehicle 100 (e.g., the position of the vehicle 100 relative to the desired path over the terrain) and/or its location (e.g., the location of the vehicle 100 relative to a target) may affect how the stability of the vehicle 100 is controlled to meet its objective.

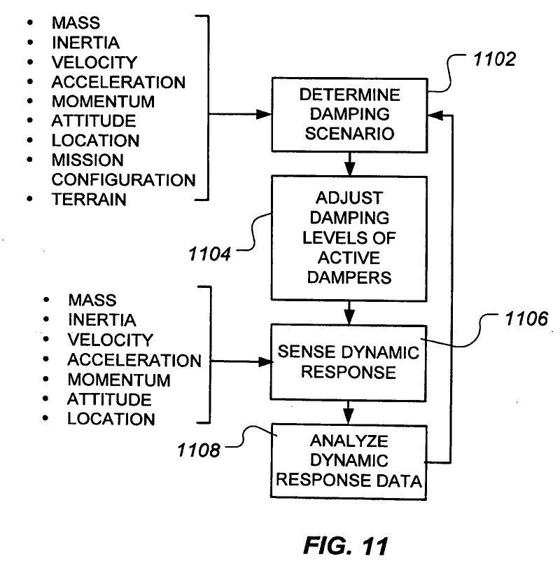

Thus, FIG. 11 shows a first illustrative embodiment of the present method of controlling the stability of an articulated vehicle, e.g., the vehicle 100 of FIGS. 1A-1C or the vehicle 1500 of FIGS. 15A-15B. In this embodiment, control is exercised based on the vehicle 100 traversing across a generally smooth terrain, such that the positions of the wheel assemblies 102 are not actively controlled with respect to the chassis 104. The damping scenario is determined (block 1102) based upon one or more characteristics of the vehicle (e.g., the mass of the sprung and unsprung components and inertia, momentum, velocity, acceleration, attitude, location, and the like) and/or the mission configuration of the vehicle. Note that these characteristics are exemplary only, and the listing is neither exhaustive nor exclusive. Other characteristics may be used in addition to, or in lieu of, those set forth herein. This determination can be made by direct measurement or by analysis of direct measurements, depending upon the implementation.

The damping levels of the active dampers are adjusted based upon the damping scenario (block 1104). The dynamic response of the vehicle 100 is sensed (block 1106) based upon at least one of various properties of the vehicle 100, such as mass, inertia, velocity, acceleration, attitude, and location. The dynamic response data (of block 1106) is analyzed (block 1108) to determine if the control should be biased depending upon the relationship between the actual dynamic response and the desired dynamic response. FIG. 11 illustrates but one particular embodiment of the present method; however, other criteria may be used to determine the damping scenario.

### B. Control for Rough Terrain

If uncontrolled, the stability of the vehicle 100 will change as it traverses over rough terrain depending upon the geometry of the terrain. For example, as the attitude of the vehicle 100 changes as it traverses rough terrain, loads on each of the wheel assemblies 102 will change accordingly. Thus, according to the present invention, spring loading on each of the suspension arms 112 and/or the pressure in each of the tires 410 is monitored to determine the loads on each wheel assembly 102. As suspension loading becomes non-uniform between the wheel assemblies 102, one or more of the wheel assemblies 102 can be articulated with respect to the chassis 104 to level the resultant loads on each wheel assembly 102.

Additionally, the active dampers may be utilized, as discussed above concerning control for smooth terrain, to dampen undesirable vibrations, oscillations, and shocks induced in the vehicle 100 as it travels over the terrain. Further, in one embodiment, at least one of the mass, inertia, velocity, acceleration, attitude, position, mission, and configuration of the vehicle 100 is additionally incorporated in the methodology of controlling its stability, as discussed above in relation to stability control for smooth terrain.

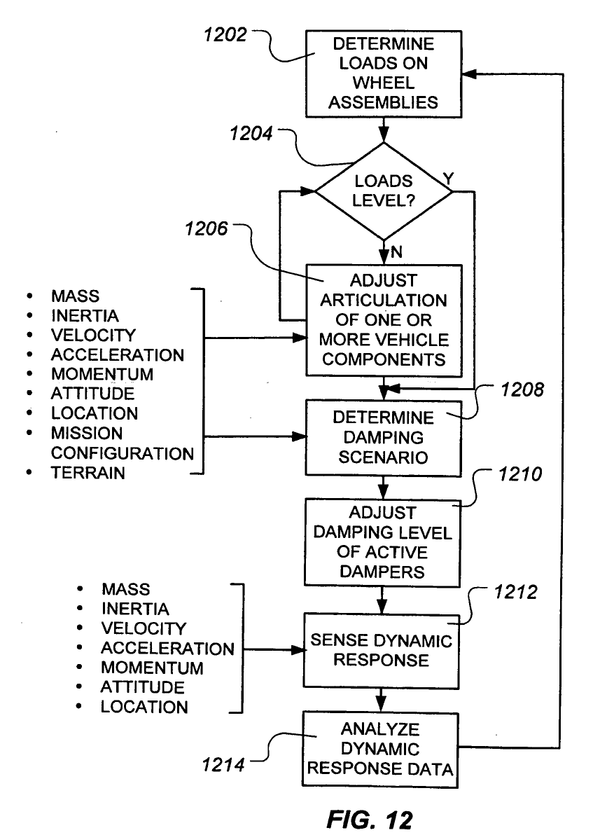

Thus, FIG. 12 shows a second illustrative embodiment of a method for controlling stability of an articulated vehicle. In this embodiment, the wheel assemblies 102 are actively controlled to maintain a desired stability of the vehicle 100. In the embodiment of FIG. 12, the loads on each of the wheel assemblies 102 are determined (block 1202). This determination comprising sensing the loads on the wheel assemblies 102 by sensing, for example, loads on the suspension arms 112 and/or air pressure in the tires 410, or the like. The determination can be made by direct measurement or by analysis of direct measurements, depending upon the implementation.

A determination is made as to whether the forces are level, i.e., whether the forces on each of the wheel assemblies 102 are substantially level, i.e., substantially equal (block 1204). For the purpose of this disclosure, the term “substantially equal” means equivalent within a predetermined tolerance range. Thus, if the loads are level, substantially equal, or substantially equalized, they are equivalent within a predetermined tolerance range. If the forces are not level, one or more of the vehicle components (e.g, the wheel assemblies 102, the turret 1602 of FIG. 16, the mast 1702 of FIG. 17, or the like) is articulated with respect to the chassis 104 to level the forces (block 1206). The leveling of the forces may, in various embodiments, be based upon one or more characteristics of the vehicle (e.g, the mass of the sprung and unsprung components, the inertia, the momentum, the velocity, the acceleration, the attitude, the location, and the like) and/or the mission configuration of the vehicle.

Once the forces are leveled, the damping scenario is determined (block 1208) based upon one or more characteristics of the vehicle (e.g, the mass of the sprung and unsprung components, the inertia, the momentum, the velocity, the acceleration, the attitude, the location, and the like) and/or the mission configuration of the vehicle, as discussed above regarding stability control over smooth terrain. The damping levels of the active dampers are adjusted based upon the damping scenario (block 1210). The dynamic response of the vehicle 100 is sensed (block 1212) based upon at least one of various properties of the vehicle 100, such as mass, inertia, velocity, acceleration, attitude, and location. The dynamic response data (of block 1212) is analyzed (block 1214) to determine if the control should be biased depending upon the relationship between the actual dynamic response and the desired dynamic response.

FIG. 12 illustrates but one particular embodiment of the present method and other criteria may be used to determine the position of the one or more wheel assemblies 102 with respect to the chassis 104 and the damping scenario. Alternatively, the methodology of FIG. 12 may omit determining the damping scenario (block 1208) and adjusting the damping levels of the active dampers (block 1210), wherein the dynamic response of the vehicle 100 is sensed (block 1212) after the one or more vehicle components are articulated (block 1206) and the dynamic response data is analyzed (block 1214) to determine if the process of articulating the one or more vehicle components (block 1206) should be biased.

### C. Predictive Control Model

Conventional control methodologies typically control objects by determining where the object is, then commanding it to a location toward its destination. Such traditional methods fall short, however, in controlling articulated vehicles (e.g., the vehicle 100 of FIGS. 1A-1C and the vehicle 1500 of FIGS. 15A-15B), as a significant portion of the vehicle's mass is unsprung and such control methods often fail to take into account the dynamic characteristics of the vehicle.

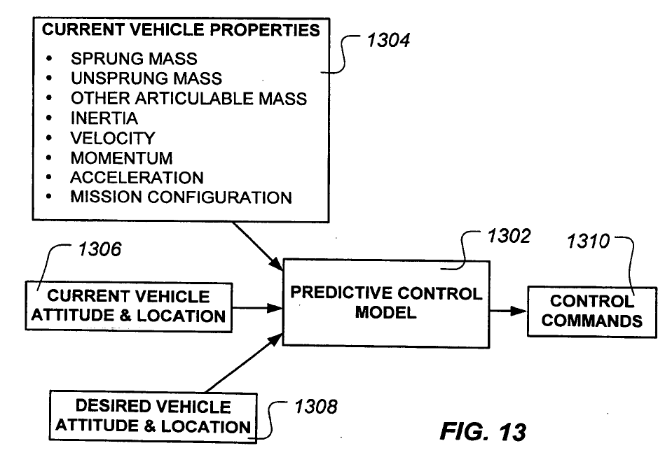

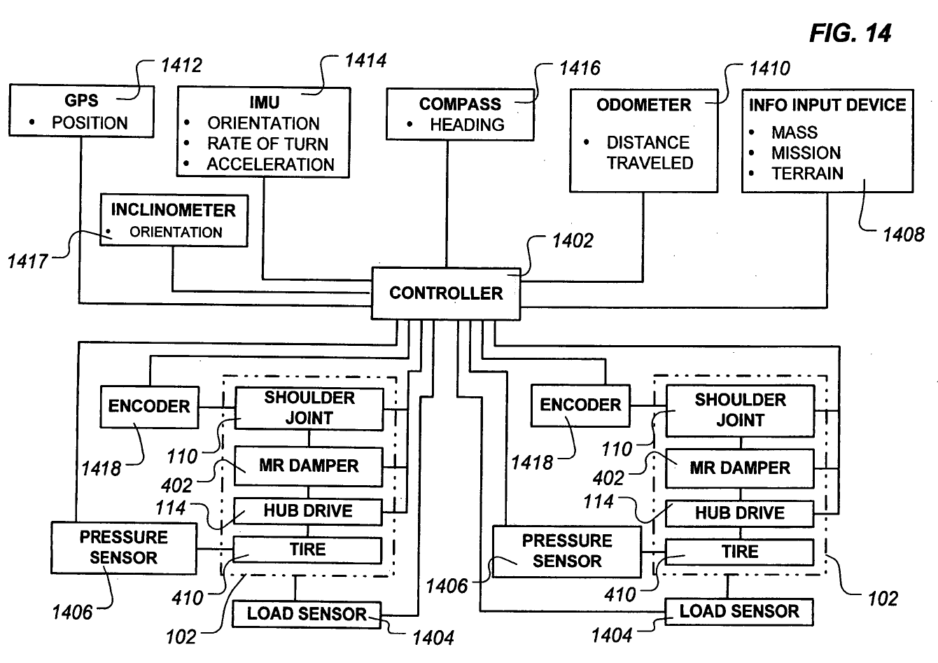

Thus, the stability control methodologies described above may be executed in a predictive manner, taking into account the dynamic properties of the vehicle 100. FIG. 13 illustrates one particular embodiment of the predictive control model according to the present invention. The predictive control model (represented by block 1302) comprises a real-time physics model of the vehicle 100 adapted to predict the motion of the vehicle 100 before the motion takes place. The model 1302 uses as inputs at least one of many current vehicle properties (represented by block 1304), such as the vehicle's sprung and unsprung mass of the vehicle 100, other articulable mass of the vehicle 100 (e.g. the turret 1602, the sensor mast 1702, and the like), and the mission configuration of the vehicle 100, as well as the inertia, velocity, acceleration, and momentum of the vehicle 100. The current vehicle attitude and location (represented by block 1306) and the desired vehicle attitude and location (represented by block 1308) are also inputs to the predictive control model 1302.

In real time, the predictive control model 1302 calculates the control commands (represented by block 1310) required to move the vehicle 100 to the desired attitude and location. The model calculates the CG and stability limits of the vehicle 100 in its current state and manipulates the wheel assemblies 102, active dampers (e.g., the rotary MR dampers 402), and any other articulable mass associated with the vehicle 100 to affect the CG and stability limits of the vehicle 100 to reach the desired location and attitude without unfavorable impacts such as a roll-over.

In the same way a skier shifts weight to his downhill ski to improve stability, the predictive control model 1302 dynamically articulates the wheel assemblies 102 (and/or other articulable masses of the vehicle 100) to place the vehicle in a more stable configuration, taking into account the vehicle's dynamic properties, CG, and stability limits, to achieve the desired vehicle state.

### III. STABILITY CONTROL SYSTEM

FIG. 13 provides one illustrative embodiment of a system 1300, which is a predictive, feed-forward controller, for controlling an attitude of an articulated vehicle. In this embodiment, a controller 1302 is coupled with various elements of the vehicle 100 such that data may be transmitted therebetween. Note that, while the vehicle 100 may include any chosen number of wheel assemblies 102, and may include turrets (e.g., the turret 1602) and/or masts (e.g., the mast 1702) for weapons and/or sensors, FIG. 13 depicts only two wheel assemblies 102 for clarity and so as not to obscure the invention. The controller 1302 is electronically coupled with each of the shoulder joints 110, rotary MR dampers 402, and hub drives 114 for controlling the actions of these elements. For example, the controller 1602 outputs to a particular hub drive 114 an electrical signal corresponding to the desired velocity of the hub drive 114 and receives therefrom a signal corresponding to the actual velocity of the hub drive 114 to control its rotational velocity.

In the illustrated embodiment, a load sensor 1304 is coupled with each of the wheel assemblies 102 and with the controller 1302 for providing the amount of loading on each of the wheel assemblies 102 to the controller 1302. A pressure sensor 1306 is provided for each of the tires 410 so that the pressure in each of the tires 410 can be provided to the controller 1302.

An input device 1308 (e.g., a user interface) allows vehicle mass, mission, terrain, and other information to be provided to the controller 1302. The controller 1608 may comprise a single-board computer, a personal computer-type apparatus, or another computing apparatus known to the art. In one embodiment, the system 1300 includes an odometer 1310 that provides distance-traveled data to the controller 1302. In this embodiment, the controller 1302 is a proportional-integral-derivative (“PID”) controller, which is adapted to calculate the velocity and acceleration of the vehicle based on data from the odometer 1310. In other embodiments, the velocity and acceleration, if needed for controlling the attitude of the vehicle 100, may be provided by other means. Based on data provided by these sensors, the controller 1302 effects control over the vehicle 100's attitude according to the methods described above and others that would be appreciated by one of ordinary skill in the art having benefit of this disclosure.

In the illustrated embodiment, the system 1300 further includes a GPS receiver 1312 adapted to provide the position of the vehicle 100 based on satellite triangulation to the controller 1302. The system 1300 may further include an inertial measurement unit (“IMU”) 1314 that may provide orientation, rate of turn, and/or acceleration data to the controller 1302. In some embodiments, the IMU may be used as a redundant system for determining the location of the vehicle 100 in the case of failure of the GPS receiver 1312. The illustrated embodiment also includes a compass 1316 for providing heading information to the controller 1302 and may include an inclinometer 1317.

It may be desirable in some embodiments for the controller 1302 to have knowledge of the articulated location of each of the wheel assemblies 102 with respect to the chassis 104. Therefore, one embodiment of the present invention includes a plurality of encoders 1318 corresponding to the plurality of wheel assemblies 102. The embodiment illustrated in FIG. 4B employs an arm position encoder 420 and a torsion bar twist encoder 422 to acquire data regarding the position of the arm 304 and the twist on the torsion bar assembly 310, respectively. From this data, the controller 1302 can determine the arm/turret speed, arm reaction torque, and estimated suspension load for the shoulder joint 210. Alternatively, resolvers or potentiometers may be used to measure for this information. Note that some embodiments may integrate a tachometer and calculate the same position data using simple calculus.

It will be appreciated by one of ordinary skill in the art having benefit of this disclosure that other means may be used to determine information needed to control the stability of the vehicle 100, 1500. Further, the scope of the present invention encompasses various embodiments wherein not every wheel assembly 102, 1502 of the vehicle 100, 1500 is controlled according to the stability control methodologies disclosed above. While the embodiments disclosed herein are implemented in an electronic control system, other types of control systems are within the scope of the present invention.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of controlling stability of a vehicle having an articulated suspension, comprising:
determining at least one dynamic property of the vehicle; and
manipulating the articulated suspension based on the at least one dynamic property to affect the stability of the vehicle.

2. A method, according to claim 1, wherein determining at least one dynamic property comprises determining at least one of the inertia, velocity, acceleration, and momentum of the vehicle.

3. A method, according to claim 1, wherein manipulating the articulated suspension comprises manipulating the articulated suspension to affect a center of gravity of the vehicle.

4. A method, according to claim 1, wherein manipulating the articulated suspension comprises manipulating the articulated suspension to affect stability limits of the vehicle.

5. A method, according to claim 1, further comprising determining at least one of an attitude and a location of the vehicle, such that manipulating the articulated suspension comprises manipulating the articulated suspension based upon the at least one of the attitude and the location of the vehicle.

6. A method, according to claim 1, further comprising determining a sprung mass and an unsprung mass of the vehicle, such that manipulating the articulated suspension comprises manipulating the articulated suspension based upon the sprung and the unsprung mass.

7. A method, according to claim 1, further comprising using a predictive model to determine how the articulated suspension is to be manipulated.

8. A method, according to claim 6, wherein using the predictive model comprises using a real-time physics model of the vehicle to determine how the articulated suspension is to be manipulated.

9. A method, according to claim 1, wherein manipulating the articulated suspension comprises articulating at least one of a plurality of wheel assemblies of the articulated suspension with respect to a chassis of the vehicle.

10. A method, according to claim 1, wherein manipulating the articulated suspension comprises actively damping the articulated suspension.

11. A method, according to claim 1, further comprising articulating at least one of a turret and a mast of the vehicle with respect to a chassis of the vehicle.

12. A method, according to claim 11, wherein articulating at least one of the turret and the mast comprises articulating at least one of the turret and the mast to substantially level loads on wheel assemblies of the articulated suspension.

13. A method, according to claim 1, wherein manipulating the articulated suspension comprises articulating at least one of a plurality of wheel assemblies with respect to a chassis of the vehicle to substantially level loads on the plurality of wheel assemblies.

14. A method of controlling stability of a vehicle having an articulated suspension, comprising:
determining a damping scenario; and
adjusting damping levels of a plurality of active dampers of the articulated suspension.

15. A method, according to claim 14, wherein determining the damping scenario comprises determining the damping scenario based upon at least one of the vehicle's mass, inertia, velocity, acceleration, attitude, position, and mission configuration.

16. A method, according to claim 14, wherein determining the damping scenario comprises determining the damping scenario based upon the terrain over which the vehicle is to travel.

17. A method, according to claim 14, further comprising sensing a dynamic response of the vehicle and analyzing the sensed dynamic response for biasing the determination of the damping scenario.

18. A method, according to claim 17, wherein sensing the dynamic response comprises sensing at least one of the vehicle's inertia, velocity, acceleration, attitude, and position.

19. A method, according to claim 17, wherein determining the damping scenario and adjusting the damping levels are carried out based upon a predictive model.

20. A method of controlling stability of a vehicle having an articulated suspension, comprising:
determining a load on each of a plurality of wheel assemblies of the articulated suspension; and
manipulating at least one component of the vehicle to affect at least one of a center of gravity of the vehicle and the vehicle's stability limits.

21. A method, according to claim 20, wherein determining the load comprises sensing a load on each suspension arm of the plurality of wheel assemblies.

22. A method, according to claim 20, wherein determining the load comprises sensing a pressure of each tire of the plurality of wheel assemblies.

23. A method, according to claim 20, wherein manipulating the at least one component comprises articulating the articulated suspension.

24. A method, according to claim 23, wherein articulating the articulated suspension comprises articulating the articulated suspension to substantially equalize the forces.

25. A method, according to claim 23, wherein articulating the articulated suspension comprises articulating at least one of the plurality of wheel assemblies with respect to a chassis of the vehicle.

26. A method, according to claim 20, wherein manipulating the at least one component comprises articulating at least one of a turret and a mast of the vehicle with respect to a chassis of the vehicle.

27. A method, according to claim 20, wherein manipulating the at least one component comprises manipulating the at least one component based upon at least one of the vehicle's mass, inertia, velocity, acceleration, attitude, position, and mission configuration.

28. A method, according to claim 20, wherein manipulating the at least one component comprises manipulating the at least one component based upon the terrain over which the vehicle is to travel.

29. A method, according to claim 20, further comprising sensing a dynamic response of the vehicle and analyzing the sensed dynamic response for biasing the manipulation of the at least one component.

30. A method, according to claim 29, wherein sensing the dynamic response comprises sensing at least one of the vehicle's inertia, velocity, acceleration, attitude, and position.

31. A method, according to claim 20, further comprising:
determining a damping scenario; and
adjusting damping levels of a plurality of active dampers of the articulated suspension.

32. A method, according to claim 31, wherein determining the damping scenario comprises determining the damping scenario based upon at least one of the vehicle's mass, inertia, velocity, acceleration, attitude, position, and mission configuration.

33. A method, according to claim 31, wherein determining the damping scenario comprises determining the damping scenario based upon the terrain over which the vehicle is to travel.

34. A method, according to claim 31, further comprising sensing a dynamic response of the vehicle and analyzing the sensed dynamic response for biasing the determination of the damping scenario.

35. A method, according to claim 31, wherein sensing the dynamic response comprises sensing at least one of the vehicle's inertia, velocity, acceleration, attitude, and position.

36. A method, according to claim 31, wherein determining the damping scenario and adjusting the damping levels are carried out based upon a predictive model.

37. A method, according to claim 20, wherein determining the load and manipulating the at least one component are carried out based upon a predictive model.

38. A system for controlling stability of an vehicle having an articulated suspension, comprising:
a plurality of sensors for sensing a state of the vehicle; and
a controller coupled with the plurality of sensors and adapted to articulate at least one component of the vehicle to affect at least one of the vehicle's center of gravity and the vehicle's stability limits.

39. A system, according to claim 38, wherein the controller comprises a predictive, feed-forward controller.

40. A system, according to claim 38, wherein the articulated suspension comprises a plurality of wheel assemblies and the plurality of sensors comprises a plurality of load sensors for sensing loads on the plurality of wheel assemblies.

41. A system, according to claim 38, wherein the articulated suspension comprises a plurality of wheel assemblies each having a tire and the plurality of sensors comprises a plurality of pressure sensors for sensing pressure within the tires.

42. A system, according to claim 38, wherein the plurality of sensors comprises at least one of a inertia sensor, a velocity sensor, an acceleration sensor, an attitude sensor, a location sensor, an odometer, a global positioning unit receiver, an inertial measurement unit, and an inclinometer.

43. A system, according to claim 38, wherein the controller employs a real-time physics model for determining how to articulate the at least one component of the vehicle.

44. A system, according to claim 38, wherein the vehicle comprises a chassis and the articulated suspension comprises a plurality of wheel assemblies articulable with respect to the chassis, such that the controller is adapted to articulate the plurality of wheel assemblies to affect at least one of the center of gravity and the stability limits of the vehicle.

45. A system, according to claim 38, wherein the vehicle comprises a chassis and at least one of a turret and a mast and the controller is adapted to articulate the at least one of the turret and the mast to affect at least one of the center of gravity and the stability limits of the vehicle.

46. A vehicle, comprising:
a chassis;
at least one component articulable with respect to the chassis;
a plurality of sensors for sensing a state of the vehicle; and
a controller coupled with the plurality of sensors and adapted to articulate the at least one articulable component to affect at least one of the vehicle's center of gravity and the vehicle's stability limits.

47. A vehicle, according to claim 46, wherein the controller comprises a predictive, feed-forward controller.

48. A vehicle, according to claim 46, wherein the articulated suspension comprises a plurality of wheel assemblies and the plurality of sensors comprises a plurality of load sensors for sensing loads on the plurality of wheel assemblies.

49. A vehicle, according to claim 46, wherein the articulated suspension comprises a plurality of wheel assemblies each having a tire and the plurality of sensors comprises a plurality of pressure sensors for sensing pressure within the tires.

50. A vehicle, according to claim 46, wherein the plurality of sensors comprises at least one of a inertia sensor, a velocity sensor, an acceleration sensor, an attitude sensor, a location sensor, an odometer, a global positioning unit receiver, an inertial measurement unit, and an inclinometer.

51. A vehicle, according to claim 46, wherein the controller employs a real-time physics model for determining how to articulate the at least one articulable component.

52. A vehicle, according to claim 46, wherein the articulated suspension comprises a plurality of wheel assemblies articulable with respect to the chassis and the controller is adapted to articulate the plurality of wheel assemblies to affect at least one of the center of gravity and the stability limits of the vehicle.

53. A vehicle, according to claim 46, wherein the vehicle comprises at least one of a turret and a mast and the controller is adapted to articulate the at least one of the turret and the mast to affect at least one of the center of gravity and the stability limits of the vehicle.
